(19) United States
(12) Patent Application Publication
(10) Pub. No.: US 2024/0005210 A1
(43) Pub. Date: Jan. 4, 2024

(54) DATA PROTECTION METHOD, APPARATUS, MEDIUM AND DEVICE

(71) Applicant: Lemon Inc., Grand Cayman (KY)

(72) Inventors: Jiankai SUN, Los Angeles, CA (US); Weihao GAO, Beijing (CN); Chong WANG, Los Angeles, CA (US); Hongyi ZHANG, Los Angeles, CA (US); Xiaobing LIU, Los Angeles, CA (US); Runliang LI, Los Angeles, CA (US); Xin YANG, Los Angeles, CA (US)

(21) Appl. No.: 18/252,559

(22) PCT Filed: Nov. 6, 2021
(86) PCT No.: PCT/SG2021/050681

§ 371 Date: May 11, 2023

(30) Foreign Application Priority Data
Nov. 13, 2020 (CN) 202011271081.0

(51) Int. Cl. G06N 20/00; G06F 21/60

(52) U.S. Cl. CPC G06N 20/00; G06F 21/60

(57) ABSTRACT

The present disclosure relates to a data protection method, an apparatus, a medium and a device. The method includes: acquiring gradient association information respectively corresponding to reference samples of a target batch of an active party of a joint training model; according to the proportion occupied respectively by reference samples of positive examples and reference samples of negative examples in all reference samples of the target batch, determining a constraint condition of the data noise to be added; determining information of said data noise according to the gradient association information and the constraint condition corresponding to the reference samples; correcting, according to the information of said data noise, an initial gradient transmission value corresponding to each reference sample, so as to obtain target gradient transmission information; and sending the target gradient transmission information to a passive party of the joint training model.

### CROSS-REFERENCE TO RELATED APPLICATIONS

This application is based on and claims the priority to the Chinese patent application No. 202011271081.0 filed on Nov. 13, 2020, the disclosure of which is hereby incorporated in its entirety into the present application.

### TECHNICAL FIELD

This disclosure relates to the field of computer technologies, and in particular, to a data protection method, apparatus, medium, and device.

### BACKGROUND

With the development of artificial intelligence technology, machine learning is applied more and more widely. In recent years, in order to protect data security and solve the problem of data islands, in a related manner, a joint training model is generally adopted to perform co-training of machine learning models on the premise of not exposing original data. For a supervised machine learning model, generally, a participant owning sample label data is called an active participant, and a participant not owning sample label data is called a passive participant. The sample label data owned by the active participant is one of important data that needs to be protected in the joint training model.

### SUMMARY

The “SUMMARY” part is provided to introduce concepts in a simplified form, which will be described in detail below in the following “DETAILED DESCRIPTION OF THE DRAWINGS” part. The “SUMMARY” part is not intended to identify key features or essential features of the claimed technical solutions, nor is it intended to limit the scope of the claimed technical solutions.

In a first aspect, the present disclosure provides a data protection method, comprising:
acquiring gradient correlation information respectively corresponding to reference samples of a target batch of an active participant of a joint training model;
determining a constraint condition for data noise to be added according to proportions of a reference sample of a positive example and a reference sample of a negative example respectively in all the reference samples of the target batch;
determining information of the data noise to be added according to the gradient correlation information corresponding to the reference samples and the constraint condition;
correcting an initial gradient transfer value corresponding to each of the reference samples according to the information of the data noise to be added to obtain target gradient transfer information, wherein the target gradient transfer information is consistent for reference samples corresponding to different sample labels in the target batch; and
sending the target gradient transfer information to a passive participant of the joint training model, so that the passive participant adjusts a parameter of the joint training model according to the target gradient transfer information.

In a second aspect, there is provided a data protection apparatus, comprising:
an acquisition module configured to acquire gradient correlation information respectively corresponding to reference samples of a target batch of an active participant of a joint training model;
a first determination module configured to determine a constraint condition for data noise to be added according to proportions of a reference sample of a positive example and a reference sample of a negative example respectively in all the reference samples of the target batch;
a second determination module configured to determine information of the data noise to be added according to the gradient correlation information corresponding to the reference samples and the constraint condition;
a correction module configured to correct an initial gradient transfer value corresponding to each of the reference samples according to the information of the data noise to be added to obtain target gradient transfer information, wherein the target gradient transfer information is consistent for reference samples corresponding to different sample labels in the target batch; and
a sending module configured to send the target gradient transfer information to a passive participant of the joint training model, so that the passive participant adjusts a parameter of the joint training model according to the target gradient transfer information.

In a third aspect, there is provided a computer-readable medium having thereon stored a computer program which, when executed by a processing means, performs the steps of the method of the first aspect.

In a fourth aspect, there is provided an electronic device, comprising:
a storage means having a computer program stored thereon;
a processing means configured to execute the computer program in the storage means to implement the steps of the method of the first aspect.

In the above technical solutions, the gradient correlation information respectively corresponding to the reference samples of the target batch of the active participant of the joint training model is acquired; the constraint condition for the data noise to be added is determined according to the respective proportions of the reference sample of the positive example and the reference sample of the negative example in all the reference samples of the target batch; the information of the data noise to be added is determined according to the gradient correlation information corresponding to the reference samples and the constraint condition; the initial gradient transfer value corresponding to each of the reference samples is corrected according to the information of the data noise to be added to obtain the target gradient transfer information, wherein target gradient transfer information corresponding to reference samples corresponding to different sample labels in the target batch is consistent; and the target gradient transfer information is sent to the passive participant of the joint training model, so that the passive participant adjusts the parameter of the joint training model according to the target gradient transfer information. Therefore, consistency of the corrected gradient transfer information corresponding to the positive and negative samples is ensured, and data information of the active participant is prevented from being leaked through the gradient transfer information, so that data security is protected effectively. Meanwhile, the data noise is constrained through the constraint condition, so that effectiveness and efficiency of the training of the joint training model based on the corrected target gradient transfer information can also be ensured.

Other features and advantages of the present disclosure will be described in detail in the subsequent “DETAILED DESCRIPTION” part.

### BRIEF DESCRIPTION OF THE DRAWINGS

The above and other features, advantages, and aspects of embodiments of the present disclosure will become more apparent in conjunction with the accompanying drawings and with reference to the following “DETAILED DESCRIPTION” part. Throughout the drawings, identical or similar reference numbers refer to identical or similar elements. It should be understood that the drawings are schematic so that components and elements are not necessarily drawn to scale. In the drawings:

FIG. 1 is a flow diagram of a data protection method according to one embodiment of the present disclosure;

FIG. 2 is a block diagram of a data protection apparatus according to one embodiment of the present disclosure;

FIG. 3 is a schematic structural diagram of an electronic device for implementing an embodiment of the present disclosure.

### DETAILED DESCRIPTION

The embodiments of the present disclosure will be described in more detail below with reference to the accompanying drawings. While certain embodiments of the present disclosure are shown in the drawings, it should be understood that the present disclosure can be implemented in various forms and should not be construed as limited to the embodiments set forth herein. Conversely, the embodiments are provided for a more complete and thorough understanding of the present disclosure. It should be understood that the drawings and the embodiments of the present disclosure are for illustration only and are not intended to limit the protection scope of the present disclosure.

It should be understood that steps recited in a method embodiment of the present disclosure can be performed in a different order, and/or performed in parallel. Moreover, the method embodiment can include an additional step and/or omit performing a shown step. The scope of the present disclosure is not limited in this respect.

The term “comprise” and variations thereof as used herein are intended to be open-minded, i.e., “comprising but not limited to”. The term “based on” is “at least partially based on”. The term “one embodiment” means “at least one embodiment”; the term “another embodiment” means “at least one other embodiment”; and the term “some embodiments” means “at least some embodiments”. Relevant definitions for other terms will be given in the following description.

It should be noted that the concepts of “first”, “second”, and the like in the present disclosure are only used for distinguishing different devices, modules or units, and are not used for limiting order or interdependence of functions performed by the devices, modules or units.

It should be noted that the modifications of “one” or “more” mentioned in this disclosure are intended to be illustrative rather than limiting, and that those skilled in the art should appreciate that they should be understood as “one or more” unless otherwise explicitly stated in the context.

Names for messages or information exchanged between multiple devices in the embodiments of the present disclosure are for illustration only, and are not intended to limit the scope of the messages or information.

In order to make those skilled in the art more understand the technical solutions provided by the embodiments of the present disclosure, related arts involved in the present disclosure are described in detail below.

A joint training model is typically used for performing co-training of machine learning models on the premise of not exposing original data. For a supervised machine learning model, generally, a participant owning sample label data is called an active participant, and a participant not owning sample label data is called a passive participant. Interaction between the active and passive participants can be performed over a network to receive or send messages, etc. As an example, the passive participant can be used for converting a training sample inputted by a sub-model of the passive participant in the joint training model into feature embedding, and an output layer of the sub-model of the passive participant can include K neurons. The passive participant can send the above feature embedding to the active participant. The active participant can train a sub-model of the active participant of the joint training model, and the sub-model of the active participant can be used for converting feature embedding obtained after combining the received feature embedding and feature embedding generated by the active participant, into a probability of predicting that the inputted training sample corresponds to a preset label. The above active participant can generate the above feature embedding by feature engineering, or by using a model similar to the sub-model of the passive participant of the above joint training model. Then, the active participant determines gradient-related information using a difference between the obtained probability and a sample label corresponding to the inputted sample. The above gradient-related information can comprise, for example, a gradient of a preset loss function with respect to each neuron in the output layer of the sub-model of the passive participant in the joint training model. Next, the active participant can send the determined gradient-related information to the passive participant, so that the passive participant adjusts a parameter corresponding to each neuron in the output layer of the sub-model of the passive participant in the joint training model according to the obtained gradient-related information.

It should be noted that the sub-model of the active participant in the above joint training model can comprise a hidden layer, a logit model, and a softmax layer. The above preset loss function can comprise a cross entropy loss function. Therefore, through the above process, the active participant and the passive participant can implement the process of joint learning.

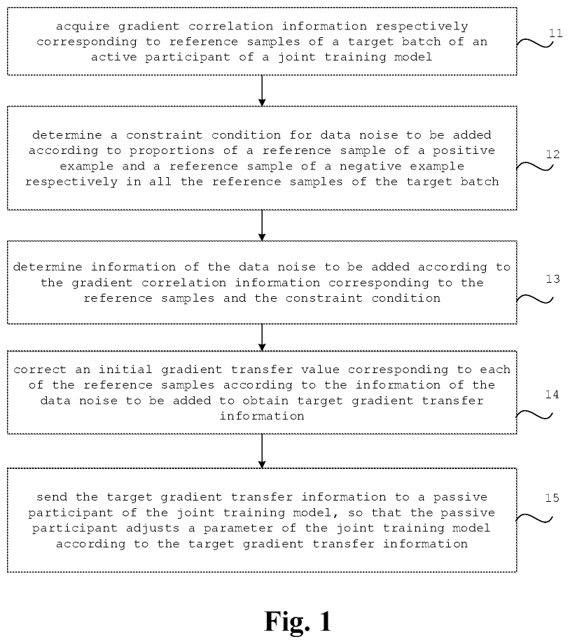

Hereinafter, the technical solutions provided by the embodiments of the present disclosure will be described in detail. FIG. 1 is a flow diagram of a data protection method according to one embodiment of the present disclosure. As shown in FIG. 1, the method can comprise the following steps.

In step 11, gradient correlation information respectively corresponding to reference samples of a target batch of an active participant of a joint training model is acquired.

In a training process of the joint training model, usually one batch of samples is inputted into an initial model every time for training, and the reference samples of the target batch are one batch of samples in one training process.

The active participant can select one batch of samples from a sample set as the reference samples of the target batch, so that the reference samples can be inputted into the joint training model to be trained, and output results corresponding to the inputted samples are obtained through forward propagation. Then, the active participant determines the gradient correlation information corresponding to the inputted samples according to the obtained output results.

In step 12, a constraint condition for data noise to be added is determined according to proportions of a reference sample of a positive example and a reference sample of a negative example respectively in all the reference samples of the target batch.

The applicants have found through research that, by performing mathematical reasoning on gradient-related information returned by the active participant, a sample label corresponding to the reference sample in the active participant will be possibly deduced, so that data of the active participant is at risk of being leaked. Based on this, in the embodiment of the present disclosure, the data noise is noise for adjusting the gradient-related information returned by the active participant, so that protection of the sample label data of the reference sample in the active participant can be realized by adding the noise, thereby realizing protection of private data of the active participant.

As described above, a passive participant needs to adjust a parameter in a sub-model of the passive participant through the gradient-related information returned by the active participant, and therefore, when the gradient-related information returned by the active participant is adjusted, it is necessary to consider not only the requirement for data protection, but also efficiency and accuracy of the joint training model. Therefore, when the data noise is determined, reasonable constraint needs to made on the added data noise to ensure the efficiency and accuracy of training the joint training model while realizing the data protection.

In step 13, information of the data noise to be added is determined according to the gradient correlation information corresponding to the reference samples and the constraint condition.

In step 14, an initial gradient transfer value corresponding to each of the reference samples is corrected according to the information of the data noise to be added to obtain target gradient transfer information, wherein target gradient transfer information corresponding to reference samples corresponding to different sample labels in the target batch is consistent.

The initial gradient transfer value corresponding to the reference sample is the above-described gradient-related information returned by the active participant in the related art, that is, the above initial gradient transfer value can be used for characterizing a basis of the parameter transferred by the active participant of the joint training model to the passive participant for adjusting the joint training model, and as an example, the above initial gradient transfer value can comprise a corresponding gradient of a preset loss function with respect to each neuron in an output layer of the model trained by the passive participant of the above joint training model, which corresponds to the inputted sample. In the embodiment of the present disclosure, by generating the data noise to be added, the initial gradient transfer value is adjusted according to the data noise to add the corresponding data noise to the initial gradient transfer value, so that target gradient transfer information corresponding to a reference sample of a positive example and a reference sample of a negative example that are obtained after the corresponding data noise is added is consistent, that is, the target gradient transfer information corresponding to the reference sample of the positive example and the reference sample of the negative example is not distinguishable, and therefore the sample label of the reference sample cannot be determined according to the target gradient transfer information.

In one possible embodiment, the initial gradient transfer value can be determined by the following steps.

As described above, in a sub-model of the active participant, a loss function shown in formula (1) can be used:

$$l ( x , c ) = - log \frac{{e}^{{y}_{c}}}{{\sum }_{j} {e}^{{y}_{i}}} \qquad ( 1 )$$

where x can be used for characterizing a sample inputted to the joint training model. c is used for characterizing a sample label corresponding to the inputted sample. y[y₁,y₂, . . . ,yᵢ,] can be used for characterizing an output of a logit model. yᵢ can be used for characterizing a score (logit score) that the label of the inputted sample is predicted as a class label i.

Therefore, a gradient of the above loss function with respect to logit can be shown as formula (2):

$${g}_{i} = \frac{\partial l ( x , c )}{\partial {y}_{i}} = - \frac{\partial log ( {e}^{{y}_{c}} ) - \partial log ( {\sum }_{j} {e}^{{y}_{i}} )}{\partial {y}_{i}} = \{ \begin{matrix}- 1 + \frac{{e}^{{y}_{i}}}{{\sum }_{j} {e}^{{y}_{i}}} , i = c \\ \frac{{e}^{{y}_{i}}}{{\sum }_{j} {e}^{{y}_{i}}} , i \neq c\end{matrix} \qquad ( 2 )$$

Then, a probability that the label of the inputted sample is predicted as the class label i can be as shown in formula (3):

$${P}_{i} = \frac{{e}^{{y}_{i}}}{{\sum }_{j} {e}^{{y}_{i}}} \qquad ( 3 )$$

Then, a corresponding gradient of the above loss function with respect to each neuron in the output layer of the sub-model trained by the passive participant of the above joint training model can be as shown in formula (4):

$$∇ {a}_{k} = {\sum }_{i} \frac{\partial l ( x , c )}{\partial {y}_{i}} \cdot \frac{\partial {y}_{i}}{\partial {a}_{k}} = {\sum }_{i} {g}_{i} \cdot \frac{\partial {y}_{i}}{\partial {a}_{k}} \qquad ( 4 )$$

In the case where the logit model is binary classification, assuming that the above class label characterizes a positive example, an initial gradient transfer value corresponding to a reference sample of the positive example can be as shown in formula (5):

$$∇ {a}_{k}^{i} = {g}_{0} \cdot \frac{\partial {y}_{0}}{\partial {a}_{k}} + {g}_{1} \cdot \frac{\partial {y}_{1}}{\partial {a}_{k}} = {P}_{0} \cdot \frac{\partial {y}_{0}}{\partial {a}_{k}} + ( - 1 + {P}_{1} ) \cdot \frac{\partial {y}_{1}}{\partial {a}_{k}} = ( 1 - {P}_{1} ) \cdot ( \frac{\partial {y}_{0}}{\partial {a}_{k}} - \frac{\partial {y}_{1}}{\partial {a}_{k}} ) \qquad ( 5 )$$

In the case that the logit model is binary classification, assuming that the above class label characterizes a negative example, an initial gradient transfer value corresponding to a reference sample of the negative example can be as shown in formula (6):

$$∇ {a}_{k}^{0} = {g}_{0} \cdot \frac{\partial {y}_{0}}{\partial {a}_{k}} + {g}_{1} \cdot \frac{\partial {y}_{1}}{\partial {a}_{k}} = ( - 1 + {P}_{0} ) \cdot \frac{\partial {y}_{0}}{\partial {a}_{k}} + {P}_{1} \cdot \frac{\partial {y}_{1}}{\partial {a}_{k}} = - {P}_{1} \cdot ( \frac{\partial {y}_{0}}{\partial {a}_{k}} - \frac{\partial {y}_{1}}{\partial {a}_{k}} ) \qquad ( 6 )$$

In step 15, the target gradient transfer information is sent to the passive participant of the joint training model so that the passive participant adjusts a parameter of the joint training model according to the target gradient transfer information.

In this embodiment, the active participant can send the target gradient transfer information obtained in the step 14 to the passive participant of the joint training model so that the above passive participant adjusts the parameter of the joint training model according to the above target gradient transfer information. As an example, the passive participant can, according to the above gradient transfer information, derive according to a chain rule to update the parameter of the joint training model on the passive participant side.

Therefore, in the above technical solution, the gradient correlation information respectively corresponding to the reference samples of the target batch of the active participant of the joint training model is acquired; the constraint condition for the data noise to be added is determined according to the respective proportions of the reference sample of the positive example and the reference sample of the negative example in all the reference samples of the target batch; the information of the data noise to be added is determined according to the gradient correlation information corresponding to the reference samples and the constraint condition; the initial gradient transfer value corresponding to each of the reference samples is corrected according to the information of the data noise to be added to obtain the target gradient transfer information, wherein target gradient transfer information corresponding to reference samples corresponding to different sample labels in the target batch is consistent; and the target gradient transfer information is sent to the passive participant of the joint training model so that the passive participant adjusts the parameter of the joint training model according to the target gradient transfer information. Therefore, consistency of the corrected gradient transfer information corresponding to the positive and negative samples is ensured, and data information of the active participant is prevented from being leaked through the gradient transfer information, so that data security is protected effectively. Meanwhile, the data noise is constrained through the constraint condition, which can also ensure effectiveness and efficiency of the training of the joint training model based on the corrected target gradient transfer information.

In order to make those skilled in the art more understand the technical solutions provided by the embodiments of the present disclosure, the above steps are described in detail below.

In one possible embodiment, the gradient correlation information comprises a sample label for characterizing a sample class and a prediction label determined based on the target gradient transfer information of the reference sample, wherein the prediction label determined based on the target gradient transfer information of the reference sample has one or more prediction methods.

As an example, the prediction method can be: to calculate a L2-norm value of the target gradient transfer information of the reference sample, determine that the prediction label corresponding to the reference sample is a positive example when the L2-norm value is greater than a preset threshold, and determine that the prediction label corresponding to the reference sample is a negative example when the L2-norm value is less than or equal to the preset threshold.

Accordingly, in the step 13, an exemplary implementation of the determining information of the data noise to be added according to the gradient correlation information corresponding to the reference samples and the constraint condition is as follows, and the step can comprise:
determining, according to a sample label and a prediction label of each of the reference samples, a mixed prediction error of predicting the reference sample based on each of the prediction methods.

The sample label of the reference sample is a real label of the reference sample, and the prediction label is used for characterizing a label predicted based on the gradient transfer information returned by the active participant to the passive participant. Therefore, for each of the prediction methods, the mixed prediction error can characterize an error of the prediction label of the reference sample determined by the prediction method.

In one possible embodiment, an implementation of the determining, according to a sample label and a prediction label of each of the reference samples, a mixed prediction error of predicting the reference sample based on each of the prediction methods is as follows, and the step can comprise:
for each of the prediction methods, determining a positive-example prediction error rate and a negative-example prediction error rate of the prediction method according to the sample label and the prediction label of each of the reference samples.

Exemplarily, a positive-example prediction error of the prediction method is used for representing that for a reference sample whose sample label is a negative example, its prediction label is a positive example; and a negative-example prediction error of the prediction method is used for representing that for a reference sample whose sample label is a positive example, its prediction label is a negative example. Then, the positive-example prediction error rate of the prediction method can be FPR (False Positive Rate), i.e., a ratio of the number of reference samples whose prediction label is a positive example among the reference samples whose sample label is a negative example, to the number of reference samples whose sample label is the negative example. Similarly, the negative-example prediction error rate of the prediction method can be FNR (False Negative Rate), i.e., a ratio of the number of reference samples whose prediction label is a negative example among the reference samples whose sample label is a positive example, to the number of reference samples whose sample label is the positive example.

Then, the mixed prediction error of predicting the reference samples based on each of the prediction methods is determined according to the positive-example prediction error rate and the negative-example prediction error rate of each of the prediction methods, so that when the mixed prediction error is determined, the prediction errors corresponding to the reference samples of the positive and negative examples can be considered at the same time, which can ensure accuracy of the mixed prediction error on one hand, and can make this method adaptable to error determination in more scenarios on the other hand, thereby improving an application range of this method.

Exemplarily, this step can comprise: determining, as the mixed prediction error, a weighted sum obtained by respectively weighting the positive-example prediction error rate and the negative-example prediction error rate according to their corresponding weights, so that the positive-example prediction error rate and the negative-example prediction error rate can be adjusted and controlled at the same time by determining the mixed prediction error.

The weights respectively corresponding to the positive-example prediction error rate and the negative-example prediction error rate of each of the prediction methods can be set according to an actual usage scenario, which is not limited by the present disclosure.

Therefore, by means of the above technical solution, the positive-example prediction error rate and the negative-example prediction error rate corresponding to the prediction method can be respectively determined, so that the mixed prediction error is determined. On one hand, weights of different prediction error rates under different scenarios can be respectively set according to actual usage scenarios, thereby meeting use requirements of a user, and on the other hand, by determining the mixed prediction error, regulation of the positive-example prediction error rate and the negative-example prediction error rate can be made at the same time, thereby improving data processing efficiency.

Thereafter, the information of the data noise to be added corresponding to the reference sample is determined according to noise parameter information which maximizes a minimum value of the mixed prediction error corresponding to each of the prediction methods and meets the constraint condition.

In this embodiment, in order to realize protection of the sample label data of the reference sample, it is necessary to ensure that the mixed prediction error is as large as possible, i.e., making the error of predicting the label of the reference sample through the target gradient transfer information as large as possible, so that the reference sample of the positive example and the reference sample of the negative example cannot be distinguished based on the target gradient transfer information, thereby realizing the protection of the label of the reference sample to protect data privacy of the active participant.

A specific determination manner of the noise parameter information is described in detail below.

Exemplarily, N₊(g⁽¹⁾,Σ₊) is used for representing a distribution of the initial gradient transfer value of the reference sample of the positive example of the target batch, where g⁽¹⁾ is used for characterizing a mean of the initial gradient transfer value of the reference sample of the positive example, which is a vector, Σ₊ is used for characterizing a covariance of the reference sample of the positive example; and N₋(g⁽⁰⁾,Σ₋) is used for representing a distribution of the initial gradient transfer value of the reference sample of the negative example of the target batch, where g⁽⁰⁾ is used for characterizing a mean of the initial gradient transfer value of the reference sample of the negative example, which is a vector, Σ₋ is used for characterizing a covariance of the reference sample of the negative example; [symbol] ₁˜(0,Σ₁) is used for representing a distribution of independently distributed data noise added to the reference sample of the positive example; [symbol] ˜(0,Σ₀) is used for representing a distribution of independently distributed data noise added to the reference sample of the negative example, wherein Σ₁ is used for characterizing a covariance of the data noise added to the reference sample of the positive example, and Σ₀ is used for characterizing a covariance of the data noise added to the reference sample of the negative example. Therefore, a distribution of the target gradient transfer information of the reference sample of the positive example can be represented as G₁˜N(g⁽¹⁾,Σ₊+Σ₁), and a distribution of the target gradient transfer information of the reference sample of the negative example can be represented as G₀˜N(g(0),Σ₋+Σ₀).

If the mixed prediction error is represented as M(G₁,G₀,A)—p*FNR+(1−p)*FPR, a maximum value of the mixed prediction error, i.e. a calculated target error, Error, can be represented as the following formula (7):

Error (G₁,G₀)=max min (M(G₁,G₀,A)) (7)
where A is used for characterizing the prediction method.

Hereinafter, p of 0.5 is taken as an example for explanation, then the target error can be further represented as the following formula (8):

Error_{0.5}(G₁,G₀)=max min(M_{0.5}(G₁,G₀,A))=05.5−0.5·TV(G₁,G₀) (8)
where TV(G₁,G₀) is used for characterizing a maximum distance between the two variables under one same prediction method, namely a total variance distance. Therefore, the problem to be solved can be further converted into determining noise parameter information that minimizes the total variance distance.

Due to complex calculation of a TV distance of a Gaussian distribution in a high-dimensional space, KL divergence can be introduced as a ceiling limit value of the TV distance in the embodiment of the present disclosure, that is:

$$TV ( {G}_{1} , {G}_{0} ) \leq \frac{\sqrt{\frac{KL ( {G}_{1} ∥ {G}_{0} )}{2} + \frac{KL ( {G}_{0} ∥ {G}_{1} )}{2}}}{2} \leq \frac{\sqrt{KL ( {G}_{1} ∥ {G}_{0} ) + KL ( {G}_{0} ∥ {G}_{1} )}}{2}$$

Therefore, the above problem to be solved can be further converted into determining noise parameter information that minimizes the KL divergence. For convenience of explanation, \sqrt{KL(G₁∥G₀)+KL(G₀∥G₁)} is denoted as sumKL, by combining the above inequality relation and formula (8), the following can be obtained:

$${Error}_{0.5} ( {G}_{1} , {G}_{0} ) \geq \frac{1}{2} - \sqrt{\frac{sumKL}{4}}$$

As can be seen from the formula, in order to determine a value when the minimum value of the mixed prediction error of the prediction method is maximized, infinite noise can be set. In this case, however, accuracy and a convergence rate of the training of the joint model based on the adjusted target gradient transfer information will be reduced. Therefore, in the embodiment of the present disclosure, the variance of the data noise to be added will be constrained through the constraint condition at the same time, so that when the joint training model is trained based on the adjusted target gradient transfer information, influence on convergence of the model can be effectively avoided.

In a possible embodiment, in order to avoid influence of the added data noise on the accuracy and the efficiency of the model parameter adjustment by the passive participant based on the gradient transfer information, the variance of the data noise to be added can be constrained through the constraint condition, so that influence of an overlarge variance of the added data noise on the convergence of the model parameter adjustment by the passive participant can be avoided, and the efficiency of training the joint training model by the passive participant and the accuracy of the model can be ensured while the data is effectively protected.

In one possible embodiment, the constraint condition is:
determining that a sum of a product of the proportion corresponding to the reference sample of the positive example and a trace of a matrix of the covariance information of the data noise to be added corresponding to the reference sample of the positive example and a product of the proportion corresponding to the reference sample of the negative example and a trace of a matrix of the covariance information of the data noise to be added corresponding to the reference sample of the negative example is less than or equal to a target value of a preset hyper-parameter.

Exemplarily, the constraint condition can be represented by the following formula (9):

q·tr(Σ₁)+(1−q)·tr(Σ₀)≤P (9),

where q is the proportion corresponding to the reference sample of the positive example, and (1−q) is the proportion corresponding to the reference sample of the negative example, let A=(aᵢⱼ) be one n-order square matrix, a sum of diagonal elements of A is called a trace of A, which is denoted as tr(A), and P represents the preset hyper-parameter.

Therefore, by use of the technical solution, the constraint condition can be determined by the preset hyper-parameter and the proportions corresponding to the positive and negative examples in the reference samples of the target batch, so that for each target batch, its corresponding constraint condition can be determined. Therefore, it can ensure to a certain extent, a matching degree of the determined information of the data noise and the reference sample of the target batch, and ensure accuracy of the determined information of the data noise, thereby providing data support for ensuring convergence efficiency and effect of the joint training model.

In a possible embodiment, the target value of the preset hyper-parameter is determined by:
determining whether a current value of the preset hyper-parameter meets a parameter condition, an initial value of the preset hyper-parameter being the initial gradient transfer value. The parameter condition can be set according to an actual usage scenario. The parameter condition is determined according to making an error of label prediction based on the target gradient transfer information greater than an error threshold,thus in this embodiment of the present disclosure, the parameter condition can be determined according to the set mixed prediction error greater than the error threshold, and exemplarily, the error threshold of the mixed prediction error can be set to L, that is:

$${Error}_{0.5} ( {G}_{1} , {G}_{0} ) \geq \frac{1}{2} - \frac{\sqrt{sumKL}}{4} \geq L ; \qquad ( 10 )$$

and according to this inequality, the parameter condition can be determined as sumKL≤(2−4L)².

If the current value of the preset hyper-parameter does not meet the parameter condition, a numerical value of the preset hyper-parameter is increased by a proportion, and the step of determining whether a current value of the preset hyper-parameter meets a parameter condition is re-executed; and
if the current value of the preset hyper-parameter meets the parameter condition, the current value of the preset hyper-parameter is determined as the target value.

Exemplarily, when the numerical value of the preset hyper-parameter is increased, the proportion can be a preset fixed proportion, or a gradually decreased dynamic proportion, and by gradually decreasing a step size of increasing the numerical value, a more accurate target value of the preset hyper-parameter is determined to a certain extent.

As an example, when the current value of the preset hyper-parameter is the initial gradient transfer value, the value can be substituted in the above inequality (10). If the constraint condition for the inequality (10) is established, this shows that the current value of the preset hyper-parameter meets the parameter condition, then the current value of the preset hyper-parameter is determined as the target value. If the constraint condition for the inequality (10) is not established, the numerical value of the preset hyper-parameter is further increased, and the target value of the preset hyper-parameter is determined by trying step by step, so that accuracy of the target value of the preset hyper-parameter can be ensured on one hand, and accuracy of the determined information of the data noise can be improved on the other hand.

Therefore, through the above process, the noise parameter information that is determined to maximize the minimum value of the mixed prediction error corresponding to each of the prediction methods and meet the constraint condition can be converted into the noise parameter information that is determined to minimize sumKL and meet the constraint condition.

Exemplarily, Σ₊=vI_{d} and Σ₋=uI_{d}, where v and u are used for representing standard deviations of the initial gradient transfer values of the reference sample of the positive example and the reference sample of the negative example, respectively, and I_{d} is used for representing a d-dimensional element matrix with diagonal elements of 1, then the problem to be solved can be converted into a problem as follows, which contains the following 4 parameters:

$${min}_{{λ}_{1}^{( 0 )} , {λ}_{1}^{( 1 )} , {λ}_{2}^{( 0 )} , {λ}_{2}^{( 1 )}} ( d - 1 ) \frac{{λ}_{2}^{( 0 )} + u}{{λ}_{2}^{( 1 )} + v} + ( d - 1 ) \frac{{λ}_{2}^{( 1 )} + v}{{λ}_{2}^{( 0 )} + u} + \frac{{λ}_{1}^{( 0 )} + u + C}{{λ}_{1}^{( 1 )} + v} + \frac{{λ}_{1}^{( 1 )} + v + C}{{λ}_{1}^{( 0 )} + u}$$

where C=∥g⁽¹⁾−g⁽⁰⁾∥₂²; and

the obeyed constraint condition is:

qλ₁⁽¹⁾+q(d−1)λ₂⁽¹⁾+(1−q)λ₁⁽⁰⁾+(1−q)(d−1)λ₂⁽⁰⁾≥P

−λ₁⁽⁰⁾≤0, −λ₁⁽¹⁾≤0, λ₂⁽⁰⁾≤0, −λ₂⁽¹⁾≤0

λ₂⁽¹⁾−λ₁⁽¹⁾≤0, λ₂⁽⁰⁾−λ₁⁽⁰⁾≤0

Therefore, by the above formula, parameter values of λ₁⁽⁰⁾, λ₁⁽¹⁾, λ₂⁽⁰⁾, λ₂⁽¹⁾, i.e., the noise parameter information, can be determined.

Therefore, by use of the above technical solution, the noise parameter information that minimizes the KL divergence and meets the constraint condition can be determined while the noise parameter information minimizes the TV distance, namely, maximizes the mixed prediction error. Therefore, the data noise determined based on the noise parameter information can ensure that the target gradient transfer information of the reference sample of the positive example and the reference sample of the negative example is consistent, while it can also meet the training requirement for the joint training model, thereby ensuring training efficiency of the joint training model while effectively protecting the sample label data of the active participant, so that use experience of a user is improved.

In some embodiments, the weights corresponding to the positive-example prediction error rate and the negative-example prediction error rate are the same; and
the determining the information of the data noise to be added corresponding to the reference sample according to noise parameter information that maximizes a minimum value of the mixed prediction error corresponding to each of the prediction methods and meets the constraint condition comprises:
respectively determining noise information respectively corresponding to the reference sample of the positive example and the reference sample of the negative example, according to parameter information respectively corresponding to the positive example and the negative example in the noise parameter information; and
respectively determining the covariance information of the data noise to be added respectively corresponding to the reference sample of the positive example and the reference sample of the negative example, according to the noise information respectively corresponding to the reference sample of the positive example and the reference sample of the negative example.

In this embodiment, for the reference sample of the positive example and the reference sample of the negative example, their corresponding noise information can be determined respectively, so that for the reference sample of the positive example and the reference sample of the negative example, their corresponding covariance information of the data noise to be added can be determined respectively.

An exemplary implementation of the respectively determining noise information respectively corresponding to the reference sample of the positive example and the reference sample of the negative example according to parameter information respectively corresponding to the positive example and the negative example in the noise parameter information is as follows, which can comprises:
for the reference sample whose sample label is the negative example, determining the noise information corresponding to the reference sample of the negative example by the following formula, wherein the noise information corresponding to the reference sample of the negative example comprises noise Y⁰ and noise Z⁰;

$${Y}^{0} = ε ( \sqrt{{λ}_{1}^{{( 0 )}^{*}} - {λ}_{2}^{{( 0 )}^{*}}} ) \frac{{g}^{( 1 )} - {g}^{( 0 )}}{{‖ {g}^{( 1 )} - {g}^{( 0 )} ‖}_{2}} \\ {Z}^{0} = \sqrt{{λ}_{2}^{{( 0 )}^{*}}} δ$$

where ε˜N(0,1), δ˜N(0, I_{d});
λ₁⁽⁰⁾* is used for representing a first negative-example parameter in the noise parameter information;
λ₂⁽⁰⁾,* is used for representing a second negative-example parameter in the noise parameter information;
g⁽¹⁾ is used for representing a mean vector of the distribution of the initial gradient transfer value corresponding to the reference sample whose sample label is the positive example;
g⁽⁰⁾ is used for representing a mean vector of the distribution of the initial gradient transfer value corresponding to the reference sample whose sample label is the negative example;
I_{d} is used for representing a d-dimensional element matrix with diagonal elements of 1; and
for the reference sample whose sample label is the positive example, determining the noise information corresponding to the reference sample of the positive example by the following formula, wherein the noise information corresponding to the reference sample of the positive example comprises noise Y¹ and noise Z¹;

$${Y}^{1} = ε ( \sqrt{{λ}_{1}^{{( 1 )}^{*}} - {λ}_{2}^{{( 1 )}^{*}}} ) \frac{{g}^{( 1 )} - {g}^{( 0 )}}{{‖ {g}^{( 1 )} - {g}^{( 0 )} ‖}_{2}} \\ {Z}^{1} = \sqrt{{λ}_{2}^{{( 1 )}^{*}}} δ$$

where λ₁⁽¹⁾,* is used for representing a first positive-example parameter in the noise parameter information; and
λ₂⁽¹⁾,* is used for representing a second positive-example parameter in the noise parameter information.

Thereafter, an exemplary implementation of the respectively determining the covariance information of the data noise to be added respectively corresponding to the reference sample of the positive example and the reference sample of the negative example according to the noise information respectively corresponding to the reference sample of the positive example and the reference sample of the negative example, can comprise:
for the reference sample whose sample label is the negative example, determining the covariance information of the data noise to be added corresponding to the reference sample of the negative example by the following formula:

$${\sum }_{0} = {Y}^{0} + {Z}^{0} = ε ( \sqrt{{λ}_{1}^{{( 0 )}^{*}} - {λ}_{2}^{{( 0 )}^{*}}} ) \frac{{g}^{( 1 )} - {g}^{( 0 )}}{{‖ {g}^{( 1 )} - {g}^{( 0 )} ‖}_{2}} + \sqrt{{λ}_{2}^{{( 0 )}^{*}}} δ ,$$

where Σ₀ is used for representing the covariance information of the data noise to be added corresponding to the reference sample whose sample label is the negative example; and
for the reference sample whose sample label is the positive example, determining the covariance information of the data noise to be added corresponding to the reference sample of the positive example by the following formula:

$${\sum }_{1} = {Y}^{1} + {Z}^{1} = ε ( \sqrt{{λ}_{1}^{{( 1 )}^{*}} - {λ}_{2}^{{( 1 )}^{*}}} ) \frac{{g}^{( 1 )} - {g}^{( 0 )}}{{‖ {g}^{( 1 )} - {g}^{( 0 )} ‖}_{2}} + \sqrt{{λ}_{2}^{{( 1 )}^{*}}} δ ,$$

where Σ₁ is used for representing the covariance information of the data noise to be added corresponding to the reference sample whose sample label is the positive example.

Therefore, by use of the above technical solution, the covariance information of the data noise to be added corresponding to the reference sample whose sample label is the negative example and the covariance information of the data noise to be added corresponding to the reference sample whose sample label is the positive example can be further determined. Therefore, after the active participant determines the initial gradient transfer value, directly according to the sample label data of its corresponding reference sample and according to its corresponding noise distribution, the corresponding data noise can be added, so that the target gradient transfer information corresponding to the reference sample of the positive example and the reference sample of the negative example is consistent, thereby realizing effective protection of the sample label data of the reference sample of the active participant while data processing efficiency can also be improved and use experience of a user is further promoted.

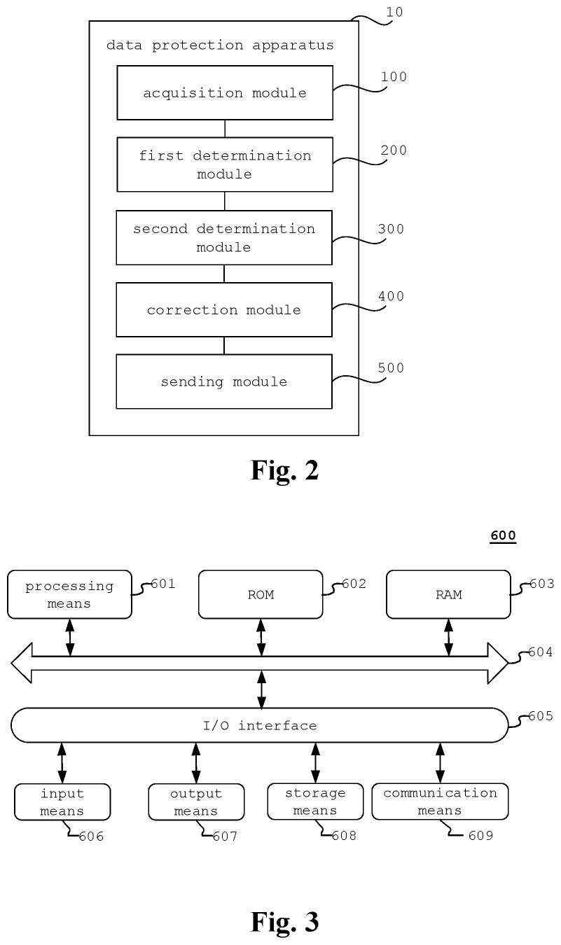

The present disclosure also provides a data protection apparatus, as shown in FIG. 2, the apparatus 10 comprising:
an acquisition module 100 configured to acquire gradient correlation information respectively corresponding to reference samples of a target batch of an active participant of a joint training model;
a first determination module 200 configured to determine a constraint condition for data noise to be added according to respective proportions of a reference sample of a positive example and a reference sample of a negative example in all the reference samples of the target batch;
a second determination module 300 configured to determine information of the data noise to be added according to the gradient correlation information corresponding to the reference samples and the constraint condition;
a correction module 400 configured to correct an initial gradient transfer value corresponding to each of the reference samples according to the information of the data noise to be added to obtain target gradient transfer information, wherein target gradient transfer information corresponding to reference samples corresponding to different sample labels in the target batch is consistent;
a sending module 500 configured to send the target gradient transfer information to a passive participant of the joint training model, so that the passive participant adjusts a parameter of the joint training model according to the target gradient transfer information.

In some embodiments, the constraint condition is used for constraining a variance of the data noise to be added.

In some embodiments, the constraint condition is:
determining that a sum of a product of the proportion corresponding to the reference sample of the positive example and a trace of a matric of covariance information of the data noise to be added corresponding to the reference sample of the positive example, and a product of the proportion corresponding to the reference sample of the negative example and a trace of a matrix of covariance information of the data noise to be added corresponding to the reference sample of the negative example is less than or equal to a target value of a preset hyper-parameter.

In some embodiments, the target value of the preset hyper-parameter is determined by:
determining whether a current value of the preset hyper-parameter meets a parameter condition, an initial value of the preset hyper-parameter being the initial gradient transfer value, wherein the parameter condition is determined according to making an error of label prediction based on the target gradient transfer information greater than an error threshold;
if the current value of the preset hyper-parameter does not meet the parameter condition, increasing a numerical value of the preset hyper-parameter by a proportion, and re-executing the step of determining whether a current value of the preset hyper-parameter meets a parameter condition; and
if the current value of the preset hyper-parameter meets the parameter condition, determining the current value of the preset hyper-parameter as the target value.

In some embodiments, the gradient correlation information comprises a sample label for characterizing a sample class and a prediction label determined based on the target gradient transfer information of the reference sample, wherein the prediction label determined based on the target gradient transfer information of the reference sample has one or more prediction methods; and
the second determination module comprises:
a first determination sub-module configured to determine, according to a sample label and a prediction label of each of the reference samples, a mixed prediction error of predicting the reference sample based on each of the prediction methods; and
a second determination sub-module configured to determine the information of the data noise to be added corresponding to the reference sample according to noise parameter information that maximizes a minimum value of the mixed prediction error corresponding to each of the prediction methods and meets the constraint condition.

In some embodiments, the first determination sub-module comprises:
a third determination sub-module configured to determine, for each of the prediction methods, a positive-example prediction error rate and a negative-example prediction error rate of the prediction method according to the sample label and the prediction label of each of the reference samples; and
a fourth determination sub-module configured to determine, according to the positive-example prediction error rate and the negative-example prediction error rate of each of the prediction methods, the mixed prediction error of predicting the reference sample based on each of the prediction methods.

In some embodiments, the fourth determination sub-module is configured to determine, as the mixed prediction error, a weighted sum obtained by respectively weighting the positive-example prediction error rate and the negative-example prediction error rate according to their corresponding weights.

In some embodiments, the weights corresponding to the positive-example prediction error rate and the negative-example prediction error rate are the same; and
the second determination sub-module comprises:
a fifth determination sub-module configured to respectively determine noise information respectively corresponding to the reference sample of the positive example and the reference sample of the negative example according to parameter information respectively corresponding to the positive example and the negative example in the noise parameter information; and
a sixth determination sub-module configured to respectively determine the covariance information of the data noise to be added respectively corresponding to the reference sample of the positive example and the reference sample of the negative example according to the noise information respectively corresponding to the reference sample of the positive example and the reference sample of the negative example.

Reference is made below to FIG. 3, which illustrates a schematic structural diagram of an electronic device 600 suitable for implementing an embodiment of the present disclosure. The terminal device in the embodiment of the present disclosure can include, but is not limited to, a mobile terminal such as a mobile phone, a notebook computer, a digital broadcast receiver, a PDA (personal digital assistant), a PAD (tablet computer), a PMP (portable multimedia player), and a vehicle-mounted terminal (e.g., a vehicle-mounted navigation terminal), and a fixed terminal such as a digital TV, and a desktop computer. The electronic device shown in FIG. 3 is only an example, and should not bring any limitation to the functions and the usage scopes of the embodiments of the present disclosure.

As shown in FIG. 3, the electronic device 600 can comprise a processing means (e.g., central processing unit, graphics processing unit, etc.) 601, which can perform various appropriate actions and processes according to a program stored in a read-only memory (ROM) 602 or a program loaded from a storage means 608 into a random access memory (RAM) 603. In the RAM 603, various programs and data needed for the operations of the electronic device 600 are also stored. The processing means 601, the ROM 602, and the RAM 603 are connected to each other via a bus 604. An input/output (I/O) interface 605 is also connected to the bus 604.

Generally, the following means can be connected to the I/O interface 605: an input means 606 including, for example, a touch screen, touch pad, keyboard, mouse, camera, microphone, accelerometer, gyroscope, or the like; an output means 607 including, for example, a liquid crystal display (LCD), a speaker, a vibrator, and the like; a storage means 608 including, for example, a magnetic tape, a hard disk, or the like; and a communication means 609. The communication means 609 can allow the electronic device 600 to be in wireless or wired communication with other means to exchange data. While FIG. 3 illustrates the electronic device 600 having the various means, it should be understood that not all the illustrated means are required to be implemented or provided. More or fewer means can be alternatively implemented or provided.

In particular, the process described above with reference to the flow diagram can be implemented as a computer software program according to the embodiments of the present disclosure. For example, the embodiments of the present disclosure comprise a computer program product, which comprises a computer program carried on a non-transitory computer-readable medium, the computer program containing program code for performing the method illustrated in the flow diagram. In such an embodiment, the computer program can be downloaded and installed from a network via the communication means 609, or installed from the storage means 608, or installed from the ROM 602. The computer program, when executed by the processing means 601, performs the above functions defined in the method of the embodiments of the present disclosure.

It should be noted that the above computer-readable medium of the present disclosure can be a computer-readable signal medium or a computer-readable storage medium or any combination of the two. The computer-readable storage medium can be, for example, but not limited to, an electronic, magnetic, optical, electromagnetic, infrared, or semiconductor system, apparatus, or device, or any combination of the above. More specific examples of the computer-readable storage medium can include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium can be any tangible medium for containing or storing a program which can be used by or in conjunction with an instruction execution system, apparatus, or device. However, in the present disclosure, the computer-readable signal medium can include a data signal propagated in baseband or as part of a carrier wave, in which computer-readable program code is carried. Such a propagated data signal can take any of a variety of forms, including, but not limited to, an electromagnetic signal, an optical signal, or any suitable combination of the above. The computer-readable signal medium can be any computer-readable medium other than the computer-readable storage medium, and the computer-readable signal medium can send, propagate, or transmit a program for use by or in conjunction with an instruction execution system, apparatus, or device. The program code contained on the computer-readable medium can be transmitted using any appropriate medium, including but not limited to: an electrical wire, an optical cable, RF (radio frequency), etc., or any suitable combination of the above.

In some embodiments, a client and server can be in communication using any currently known or future developed network protocol, such as HTTP (HyperText Transfer Protocol), and can be in interconnection with any form or medium of digital data communication (e.g., a communication network). Examples of the communication network include a local area network (“LAN”), a wide area network (“WAN”), an internet (e.g., the Internet), and a peer-to-peer network (e.g., ad hoc peer-to-peer network), as well as any currently known or future developed network.

The above computer-readable medium can be contained in the electronic device; or can be separate and not assembled into the electronic device.

The above computer-readable medium has thereon carried one or more programs which, when executed by the electronic device, cause the electronic device to: acquire gradient correlation information respectively corresponding to reference samples of a target batch of an active participant of a joint training model; determine a constraint condition for data noise to be added according to respective proportions of a reference sample of a positive example and a reference sample of a negative example in all the reference samples of the target batch; determine information of the data noise to be added according to the gradient correlation information corresponding to the reference samples and the constraint condition; correct an initial gradient transfer value corresponding to each of the reference samples according to the information of the data noise to be added to obtain target gradient transfer information, wherein target gradient transfer information corresponding to reference samples corresponding to different sample labels in the target batch is consistent; and send the target gradient transfer information to a passive participant of the joint training model, so that the passive participant adjusts a parameter of the joint training model according to the target gradient transfer information.

Computer program code for performing operations of the present disclosure can be written in one or more programming languages or a combination thereof, which include but are not limited to an object-oriented programming language such as Java, Smalltalk, C++, and also include a conventional procedural programming language, such as the “C” programming language or similar programming languages. The program code can be executed entirely on a user's computer, partly on the user's computer, as a stand-alone software package, partly on the user's computer and partly on a remote computer, or entirely on the remote computer or server. In a scenario where a remote computer is involved, the remote computer can be connected to the user's computer through any type of network, including a local area network (LAN) or a wide area network (WAN), or can be connected to an external computer (for example, connected through the Internet using an Internet service provider).

The flow diagrams and block diagrams in the accompanying drawings illustrate the possibly implemented architecture, functions and operations of the systems, methods and computer program products according to the various embodiments of the present disclosure. In this regard, each block in the flow diagrams or block diagrams can represent one module, program segment, or portion of code, which comprises one or more executable instructions for implementing a specified logical function. It should also be noted that, in some alternative implementations, functions noted in blocks can occur in a different order from an order noted in the drawings. For example, two blocks shown in succession can, in fact, be executed substantially concurrently, and sometimes they can also be executed in a reverse order, which depends upon functions involved. It will also be noted that each block of the block diagrams and/or flow diagrams, and a combination of blocks in the block diagrams and/or flow diagrams, can be implemented by a special-purpose hardware-based system that perform specified functions or operations, or a combination of special-purpose hardware and computer instructions.

The involved modules described in the embodiments of the present disclosure can be implemented by software or hardware. The name of the module does not constitute a limitation on the module itself in some cases, for example, the acquisition module can also be described as a “module that acquires gradient correlation information respectively corresponding to reference samples of a target batch of an active participant of a joint training model”.

The functions described above herein can be at least partially performed by one or more hardware logic components. For example, without limitation, an exemplary-type hardware logic component that can be used includes: a field programmable gate array (FPGA), an application specific integrated circuit (ASIC), an application specific standard product (ASSP), a system on chip (SOC), a complex programmable logic devices (CPLD), and the like.

In the context of this disclosure, a machine-readable medium can be a tangible medium, which can contain or store a program for use by or in conjunction with an instruction execution system, apparatus, or device. The machine-readable medium can be a machine-readable signal medium or a machine-readable storage medium. The machine-readable medium can include, but is not limited to, an electronic, magnetic, optical, electromagnetic, infrared, or semiconductor system, apparatus, or device, or any suitable combination of the above. More specific examples of the machine-readable storage medium would include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

According to one or more embodiments of the present disclosure, example 1 provides a data protection method, comprising:
acquiring gradient correlation information respectively corresponding to reference samples of a target batch of an active participant of a joint training model;
determining a constraint condition for data noise to be added according to respective proportions of a reference sample of a positive example and a reference sample of a negative example in all the reference samples of the target batch;
determining information of the data noise to be added according to the gradient correlation information corresponding to the reference samples and the constraint condition;
correcting an initial gradient transfer value corresponding to each of the reference samples according to the information of the data noise to be added to obtain target gradient transfer information, wherein target gradient transfer information corresponding to reference samples corresponding to different sample labels in the target batch is consistent; and
sending the target gradient transfer information to a passive participant of the joint training model, so that the passive participant adjusts a parameter of the joint training model according to the target gradient transfer information.

According to one or more embodiments of the present disclosure, example 2 provides the method of example 1, wherein the constraint condition is used for constraining a variance of the data noise to be added.

According to one or more embodiments of the present disclosure, example 3 provides the method of example 1 or example 2, wherein the constraint condition is:
determining that a sum of a product of the proportion corresponding to the reference sample of the positive example and a trace of a matrix of covariance information of the data noise to be added corresponding to the reference sample of the positive example, and a product of the proportion corresponding to the reference sample of the negative example and a trace of a matrix of covariance information of the data noise to be added corresponding to the reference sample of the negative example is less than or equal to a target value of a preset hyper-parameter.

According to one or more embodiments of the present disclosure, example 4 provides the method of example 3, wherein the target value of the preset hyper-parameter is determined by:
determining whether a current value of the preset hyper-parameter meets a parameter condition, an initial value of the preset hyper-parameter being the initial gradient transfer value, wherein the parameter condition is determined according to making an error of label prediction based on the target gradient transfer information greater than an error threshold;
if the current value of the preset hyper-parameter does not meet the parameter condition, increasing a numerical value of the preset hyper-parameter by a proportion, and re-executing the step of determining whether a current value of the preset hyper-parameter meets a parameter condition; and
if the current value of the preset hyper-parameter meets the parameter condition, determining the current value of the preset hyper-parameter as the target value.

According to one or more embodiments of the present disclosure, example 5 provides the method of example 1, wherein the gradient correlation information comprises a sample label for characterizing a sample class and a prediction label determined based on the target gradient transfer information of the reference sample, wherein the prediction label determined based on the target gradient transfer information of the reference sample has one or more prediction methods;
the determining information of the data noise to be added according to the gradient correlation information corresponding to the reference samples and the constraint condition comprises:
determining, according to a sample label and a prediction label of each of the reference samples, a mixed prediction error of predicting the reference sample based on each of the prediction methods; and
determining the information of the data noise to be added corresponding to the reference sample according to noise parameter information that maximizes a minimum value of the mixed prediction error corresponding to each of the prediction methods and meets the constraint condition.

According to one or more embodiments of the present disclosure, example 6 provides the method of example 5, wherein the determining, according to a sample label and a prediction label of each of the reference samples, a mixed prediction error of predicting the reference sample based on each of the prediction methods comprises:
for each of the prediction methods, determining a positive-example prediction error rate and a negative-example prediction error rate of the prediction method according to the sample label and the prediction label of each of the reference samples; and
determining, according to the positive-example prediction error rate and the negative-example prediction error rate of each of the prediction methods, the mixed prediction error of predicting the reference sample based on each of the prediction methods.

According to one or more embodiments of the present disclosure, example 7 provides the method of example 6, wherein the determining, according to the positive-example prediction error rate and the negative-example prediction error rate of each of the prediction methods, the mixed prediction error of predicting the reference sample based on each of the prediction methods comprises:
determining, as the mixed prediction error, a weighted sum obtained by respectively weighting the positive-example prediction error rate and the negative-example prediction error rate according to their corresponding weights.

According to one or more embodiments of the present disclosure, example 8 provides the method of example 5, wherein the weights corresponding to the positive-example prediction error rate and the negative-example prediction error rate are the same; and
the determining the information of the data noise to be added corresponding to the reference sample according to noise parameter information that maximizes a minimum value of the mixed prediction error corresponding to each of the prediction methods and meets the constraint condition comprises:
respectively determining noise information respectively corresponding to the reference sample of the positive example and the reference sample of the negative example according to parameter information respectively corresponding to the positive example and the negative example in the noise parameter information; and
respectively determining the covariance information of the data noise to be added respectively corresponding to the reference sample of the positive example and the reference sample of the negative example according to the noise information respectively corresponding to the reference sample of the positive example and the reference sample of the negative example.

According to one or more embodiments of the present disclosure, example 9 provides a data protection apparatus, comprising:
an acquisition module configured to acquire gradient correlation information respectively corresponding to reference samples of a target batch of an active participant of a joint training model;
a first determination module configured to determine a constraint condition for data noise to be added according to respective proportions of a reference sample of a positive example and a reference sample of a negative example in all the reference samples of the target batch;
a second determination module configured to determine information of the data noise to be added according to the gradient correlation information corresponding to the reference samples and the constraint condition;
a correction module configured to correct an initial gradient transfer value corresponding to each of the reference samples according to the information of the data noise to be added to obtain target gradient transfer information, wherein target gradient transfer information corresponding to reference samples corresponding to different sample labels in the target batch is consistent; and
a sending module configured to send the target gradient transfer information to a passive participant of the joint training model, so that the passive participant adjusts a parameter of the joint training model according to the target gradient transfer information.

According to one or more embodiments of the present disclosure, example 10 provides a computer-readable medium having thereon stored a computer program which, when executed by a processing means, implements the steps of the method of any of examples 1 to 8.

According to one or more embodiments of the present disclosure, example 11 provides an electronic device, comprising:
a storage means having a computer program stored thereon;
a processing means configured to execute the computer program in the storage means to implement the steps of the method of any of examples 1 to 8.

The foregoing description is only preferred embodiments of the present disclosure and explanations for technical principles used. It should be appreciated by those skilled in the art that the disclosed scope involved in the present disclosure is not limited to a technical solution formed by a specific combination of the above technical features, but also should encompass another technical solution formed by an arbitrary combination of the above technical features or their equivalent features without departing from the above disclosed concept, for example, a technical solution formed by performing mutual replacement for the above features and technical features with functions similar to those disclosed (but not limited to) in this disclosure.

Furthermore, while operations are depicted in a specific order, this should not be understood as requiring that these operations be performed in the specific order shown or in a sequential order. Under certain circumstances, multitasking and parallel processing may be advantageous. Likewise, while several specific implementation details are included in the above discussion, these should not be construed as limitations on the scope of the present disclosure. Certain features that are described in the context of separate embodiments can also be implemented in combination in a single embodiment. Conversely, various features that are described in the context of a single embodiment can also be implemented separately or in any suitable sub-combination in multiple embodiments.

Although the subject matter has been described in language specific to structural features and/or method logical actions, it should be understood that the subject matter defined in the attached claims is not necessarily limited to the specific features or actions described above. On the contrary, the specific features and actions described above are exemplary forms of implementing the claims. With regard to the apparatus in the above embodiment, the specific manner in which each module performs the operation has been described in detail in the embodiment related to the method, and will not be described in detail here.

What is claimed is:

1. A data protection method, comprising:
acquiring gradient correlation information respectively corresponding to reference samples of a target batch of an active participant of a joint training model;
determining a constraint condition for data noise to be added according to proportions of a reference sample of a positive example and a reference sample of a negative example respectively in all the reference samples of the target batch;
determining information of the data noise to be added according to the gradient correlation information corresponding to the reference samples and the constraint condition;
correcting an initial gradient transfer value corresponding to each of the reference samples according to the information of the data noise to be added to obtain target gradient transfer information, wherein the target gradient transfer information is consistent for reference samples corresponding to different sample labels in the target batch; and
sending the target gradient transfer information to a passive participant of the joint training model, so that the passive participant adjusts a parameter of the joint training model according to the target gradient transfer information.

2. The data protection method according to claim 1, wherein the constraint condition is used for constraining a variance of the data noise to be added.

3. The data protection method according to claim 1, wherein the constraint condition is:
determining that a sum of a product of the proportion corresponding to the reference sample of the positive example and a trace of a matrix of covariance information of the data noise to be added corresponding to the reference sample of the positive example, and a product of the proportion corresponding to the reference sample of the negative example and a trace of a matrix of covariance information of the data noise to be added corresponding to the reference sample of the negative example is less than or equal to a target value of a preset hyper-parameter.

4. The data protection method according to claim 3, wherein the target value of the preset hyper-parameter is determined by:
determining whether a current value of the preset hyper-parameter meets a parameter condition, an initial value of the preset hyper-parameter being the initial gradient transfer value, wherein the parameter condition is determined according to making an error of label prediction based on the target gradient transfer information greater than an error threshold;
in a case where the current value of the preset hyper-parameter does not meet the parameter condition, increasing a numerical value of the preset hyper-parameter by a proportion, and re-executing the determining whether the current value of the preset hyper-parameter meets the parameter condition; and
in a case where the current value of the preset hyper-parameter meets the parameter condition, determining the current value of the preset hyper-parameter as the target value.

5. The data protection method according to claim 1, wherein the gradient correlation information comprises a sample label for characterizing a sample class and a prediction label determined based on the target gradient transfer information of the reference sample, wherein the prediction label is determined based on the target gradient transfer information of the reference sample by one or more prediction methods;
the determining information of the data noise to be added according to the gradient correlation information corresponding to the reference samples and the constraint condition comprises:
determining, according to a sample label and a prediction label of each of the reference samples, a mixed prediction error of predicting the reference sample based on each of the prediction methods; and
determining the information of the data noise to be added corresponding to the reference sample according to noise parameter information that maximizes a minimum value of the mixed prediction error corresponding to each of the prediction methods and meets the constraint condition.

6. The data protection method according to claim 5, wherein the determining,
according to a sample label and a prediction label of each of the reference samples, a mixed prediction error of predicting the reference sample based on each of the prediction methods comprises:
for each of the prediction methods, determining a positive-example prediction error rate and a negative-example prediction error rate of the prediction method according to the sample label and the prediction label of each of the reference samples; and
determining, according to the positive-example prediction error rate and the negative-example prediction error rate of each of the prediction methods, the mixed prediction error of predicting the reference sample based on each of the prediction methods.

7. The data protection method according to claim 6, wherein the determining,
according to the positive-example prediction error rate and the negative-example prediction error rate of each of the prediction methods, the mixed prediction error of predicting the reference sample based on each of the prediction methods comprises:
determining, as the mixed prediction error, a weighted sum obtained by respectively weighting the positive-example prediction error rate and the negative-example prediction error rate according to corresponding weights.

8. The data protection method according to claim 5, wherein the weights corresponding to the positive-example prediction error rate and the negative-example prediction error rate are same; and
the determining the information of the data noise to be added corresponding to the reference sample according to noise parameter information that maximizes a minimum value of the mixed prediction error corresponding to each of the prediction methods and meets the constraint condition comprises:
determining noise information respectively corresponding to the reference sample of the positive example and the reference sample of the negative example according to parameter information respectively corresponding to the positive example and the negative example in the noise parameter information; and
determining the covariance information of the data noise to be added respectively corresponding to the reference sample of the positive example and the reference sample of the negative example according to the noise information respectively corresponding to the reference sample of the positive example and the reference sample of the negative example.

9. The data protection method according to claim 1, wherein the initial gradient transfer value comprises a corresponding gradient of a preset loss function with respect to each neuron in an output layer of a sub-model trained by the passive participant of the joint training model.

10. The data protection method according to claim 4, wherein in a case where the numerical value of the preset hyper-parameter is increased by the proportion, the proportion is a preset fixed proportion or a gradually decreased dynamic proportion.

11. The data protection method according to claim 5, wherein the prediction method is to calculate a L2-norm value of the target gradient transfer information of the reference sample, determine the prediction label corresponding to the reference sample as the positive example in a case where the L2-norm value is greater than a preset threshold, and determine the prediction label corresponding to the reference sample as the negative example in a case where the L2-norm value is less than or equal to the preset threshold.

12. (canceled)

13. A non-transitory computer-readable medium having thereon stored a computer program which, when executed by a processing means, implements a data protection comprising:
acquiring gradient correlation information respectively corresponding to reference samples of a target batch of an active participant of a joint training model;
determining a constraint condition for data noise to be added according to proportions of a reference sample of a positive example and a reference sample of a negative example respectively in all the reference samples of the target batch;
determining information of the data noise to be added according to the gradient correlation information corresponding to the reference samples and the constraint condition;
correcting an initial gradient transfer value corresponding to each of the reference samples according to the information of the data noise to be added to obtain target gradient transfer information, wherein the target gradient transfer information is consistent for reference samples corresponding to different sample labels in the target batch; and
sending the target gradient transfer information to a passive participant of the joint training model, so that the passive participant adjusts a parameter of the joint training model according to the target gradient transfer information.

14. An electronic device, comprising:
a storage means having a computer program stored thereon; and
a processing means configured to execute the computer program in the storage means to implement a data protection method comprising:
acquiring gradient correlation information respectively corresponding to reference samples of a target batch of an active participant of a joint training model;
determining a constraint condition for data noise to be added according to proportions of a reference sample of a positive example and a reference sample of a negative example respectively in all the reference samples of the target batch;
determining information of the data noise to be added according to the gradient correlation information corresponding to the reference samples and the constraint condition;
correcting an initial gradient transfer value corresponding to each of the reference samples according to the information of the data noise to be added to obtain target gradient transfer information, wherein the target gradient transfer information is consistent for reference samples corresponding to different sample labels in the target batch; and
sending the target gradient transfer information to a passive participant of the joint training model, so that the passive participant adjusts a parameter of the joint training model according to the target gradient transfer information.

15-16. (canceled)

17. The non-transitory computer-readable medium according to claim 13, wherein the constraint condition is used for constraining a variance of the data noise to be added.

18. The non-transitory computer-readable medium according to claim 13, wherein the constraint condition is:
determining that a sum of a product of the proportion corresponding to the reference sample of the positive example and a trace of a matrix of covariance information of the data noise to be added corresponding to the reference sample of the positive example, and a product of the proportion corresponding to the reference sample of the negative example and a trace of a matrix of covariance information of the data noise to be added corresponding to the reference sample of the negative example is less than or equal to a target value of a preset hyper-parameter.

19. The non-transitory computer-readable medium according to claim 18, wherein the target value of the preset hyper-parameter is determined by:
determining whether a current value of the preset hyper-parameter meets a parameter condition, an initial value of the preset hyper-parameter being the initial gradient transfer value, wherein the parameter condition is determined according to making an error of label prediction based on the target gradient transfer information greater than an error threshold;
in a case where the current value of the preset hyper-parameter does not meet the parameter condition, increasing a numerical value of the preset hyper-parameter by a proportion, and re-executing the determining whether the current value of the preset hyper-parameter meets the parameter condition; and
in a case where the current value of the preset hyper-parameter meets the parameter condition, determining the current value of the preset hyper-parameter as the target value.

20. The non-transitory computer-readable medium according to claim 13, wherein the gradient correlation information comprises a sample label for characterizing a sample class and a prediction label determined based on the target gradient transfer information of the reference sample, wherein the prediction label is determined based on the target gradient transfer information of the reference sample by one or more prediction methods;
the determining information of the data noise to be added according to the gradient correlation information corresponding to the reference samples and the constraint condition comprises:
determining, according to a sample label and a prediction label of each of the reference samples, a mixed prediction error of predicting the reference sample based on each of the prediction methods; and
determining the information of the data noise to be added corresponding to the reference sample according to noise parameter information that maximizes a minimum value of the mixed prediction error corresponding to each of the prediction methods and meets the constraint condition.

21. The electronic device according to claim 14, wherein the constraint condition is used for constraining a variance of the data noise to be added.

22. The electronic device according to claim 14, wherein the constraint condition is:
determining that a sum of a product of the proportion corresponding to the reference sample of the positive example and a trace of a matrix of covariance information of the data noise to be added corresponding to the reference sample of the positive example, and a product of the proportion corresponding to the reference sample of the negative example and a trace of a matrix of covariance information of the data noise to be added corresponding to the reference sample of the negative example is less than or equal to a target value of a preset hyper-parameter.

23. The electronic device according to claim 22, wherein the target value of the preset hyper-parameter is determined by:
determining whether a current value of the preset hyper-parameter meets a parameter condition, an initial value of the preset hyper-parameter being the initial gradient transfer value, wherein the parameter condition is determined according to making an error of label prediction based on the target gradient transfer information greater than an error threshold;
in a case where the current value of the preset hyper-parameter does not meet the parameter condition, increasing a numerical value of the preset hyper-parameter by a proportion, and re-executing the determining whether the current value of the preset hyper-parameter meets the parameter condition; and
in a case where the current value of the preset hyper-parameter meets the parameter condition, determining the current value of the preset hyper-parameter as the target value.
